(19) United States
(12) Patent Application Publication
(10) Pub. No.: US 2026/0305523 A1
(43) Pub. Date: Oct. 8, 2026

(54) CONTROL METHOD AND APPARATUS FOR LOAD OF MOVABLE PLATFORM, AND MOVABLE PLATFORM AND MEDIUM

(71) Applicant: SZ DJI TECHNOLOGY CO., LTD., Shenzhen (CN)

(72) Inventors: Zichen LV, Shenzhen (CN); Wei XIONG, Shenzhen (CN); Penghui ZHANG, Shenzhen (CN)

(21) Appl. No.: 19/683,457

(22) Filed: May 20, 2026

Related U.S. Application Data
(63) Continuation of application No. PCT/CN2023/133023, filed on Nov. 21, 2023.

(51) Int. Cl. A01C 21/00; A01C 7/20; B64U 10/16; B64U 101/40

(52) U.S. Cl. CPC A01C 21/00; A01C 7/20; B64U 10/16; B64U 2101/40

(57) ABSTRACT

A control method includes automatically detecting load attributes of a load carried by a movable platform and configured to deliver a material, determining control parameters based on the load attributes, and controlling the load to deliver the material according to the control parameters. The load attributes includes a first load attribute and a second load attribute different from the first load attribute. The control parameters include a first control parameter corresponding to the first load attribute and a second control parameter corresponding to the second load attribute. The first control parameter is different from the second control parameter.

### CROSS-REFERENCE TO RELATED APPLICATION

This application is a continuation of International Application No. PCT/CN2023/133023, filed on Nov. 21, 2023, the entire content of which is incorporated herein by reference.

### TECHNICAL FIELD

The present disclosure generally relates to the field of movable platform technology, and, more particularly, to a control method for a load of a movable platform, an apparatus, a movable platform and a storage medium.

### BACKGROUND

With the development of movable platform technology, more and more users are adopting movable platforms for operations, especially for plant protection operations such as pesticide spraying, fertilizer spraying, crop sowing, or fertilizer sowing. This offers advantages such as minimal damage to crops, high pesticide utilization, and reduced labor intensity.

Different workloads are suitable for different work scenarios. Taking sowing scenario as an example, nowadays, movable platforms generally use screw conveyor-type sowing apparatuses for material sowing, and different screw conveyor types need to be adapted for different operational scenarios. Generally, the screw conveyor type is identified manually, and the screw conveyor used in the actual operation is replaced manually according to different operational scenarios. However, manual operations often involve lapses such as forgetfulness or operational errors. These issues can lead to serious operational accidents, making it difficult to ensure the accuracy and safety of the movable platform's tasks, resulting in poor user experience and relatively low level of intelligence.

### SUMMARY

In accordance with the disclosure, there is provided a control method including automatically detecting load attributes of a load carried by a movable platform and configured to deliver a material, determining control parameters based on the load attributes, and controlling the load to deliver the material according to the control parameters. The load attributes includes a first load attribute and a second load attribute different from the first load attribute. The control parameters include a first control parameter corresponding to the first load attribute and a second control parameter corresponding to the second load attribute. The first control parameter is different from the second control parameter.

Also in accordance with the disclosure, there is provided a control method including obtaining a material category of a target material to be delivered by a load carried by a movable platform, automatically determining target load attributes of the load based on the material category, and controlling the load to deliver the target material according to control parameters corresponding to the target load attributes. The target load attributes include a first target load attribute and a second target load attribute different from the first target load. The control parameters include a first control parameter corresponding to the first target load attribute and a second control parameter corresponding to the second target load attribute. The first control parameter is different from the second control parameter.

Also in accordance with the disclosure, there is provided a movable platform including a platform body configured to carry a load configured to deliver a material, a power system disposed at the platform body and configured to enable the movable platform to move, and a control apparatus disposed at the platform body and configured to automatically detect load attributes of the load, determine control parameters based on the load attributes, and control the load to deliver the material according to the control parameters. The load attributes includes a first load attribute and a second load attribute different from the first load attribute. The control parameters include a first control parameter corresponding to the first load attribute and a second control parameter corresponding to the second load attribute. The first control parameter is different from the second control parameter.

### BRIEF DESCRIPTION OF THE DRAWINGS

To more clearly illustrate the technical solutions of the embodiments of the present disclosure, the accompanying drawings in the following description of the embodiments will be briefly introduced. The accompanying drawings described below are some embodiments of the present disclosure. For those skilled in the art, other drawings can be obtained based on these drawings without creative effort.

FIG. 1 is a schematic diagram of the structure of a movable platform implementing the control method consistent with the present disclosure.

FIG. 2 is a schematic flowchart of a control method of a load of a movable platform consistent with the present disclosure.

FIG. 3 is a schematic flowchart of the sub-processes of the control method in FIG. 2.

FIG. 4 shows an example of magnets arrangement on a screw conveyor of the present disclosure.

FIG. 5 shows another example of magnets arrangement on a screw conveyor of the present disclosure.

FIG. 6 shows another example of magnets arrangement on a screw conveyor of the present disclosure.

FIG. 7 is a schematic flowchart of another control method of a load of a movable platform consistent with the present disclosure.

FIG. 8 is a schematic flowchart of another control method of a load of a movable platform consistent with the present disclosure.

FIG. 9 is a schematic structural diagram of a control apparatus consistent with the present disclosure.

FIG. 10 is a schematic structural diagram of a movable platform consistent with the present disclosure embodiment.

### DETAILED DESCRIPTION OF THE EMBODIMENTS

The technical solutions in the embodiments of the present disclosure will be described below with reference to the accompanying drawings. The described embodiments are only some embodiments of the present disclosure, not all embodiments. Based on described embodiments, all other embodiments obtained by those skilled in the art without creative effort are within the scope of the present disclosure.

The flowcharts shown in the accompanying drawings are merely illustrative and do not necessarily include all content and operations/processes, nor do they necessarily have to be executed in the described order. For example, some operations/processes can be broken down, combined, or partially merged, so the actual execution order may change according to the actual situation.

Some embodiments of the present disclosure are described in detail below with reference to the accompanying drawings. Unless otherwise specified, the following embodiments and features can be combined with each other.

Nowadays, movable platforms generally use screw conveyor-type sowing apparatuses for material sowing, and different screw conveyor types need to be adapted for different operational scenarios. Generally, the screw conveyor type is identified manually, and the screw conveyor used in the actual operation is replaced manually according to different operational scenarios. However, manual operations often involve lapses such as forgetfulness or operational errors. These issues can lead to serious operational accidents, making it difficult to ensure the accuracy and safety of the movable platform's tasks, resulting in poor user experience and relatively low level of intelligence.

To solve the above problems, embodiments of the present disclosure provide a control method, apparatus, movable platform, and storage medium. This control method automatically detects the load attributes and determines the corresponding control parameters based on the load attributes. The movable platform then controls the load to deliver materials according to the determined control parameters. This eliminates the need for manual identification of the load attributes of the load, preventing operational accidents caused by user forgetfulness or operational errors. This greatly improves the operational accuracy and safety of the movable platform and enhances the intelligence level of the movable platform.

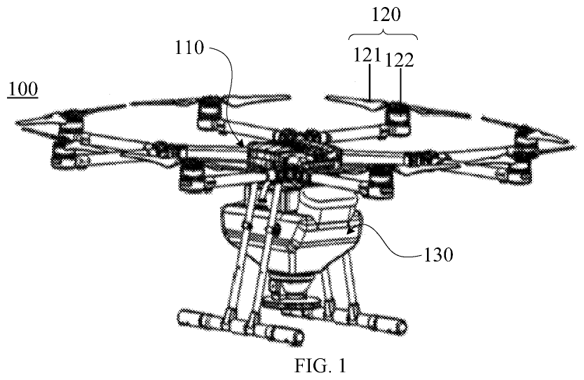

FIG. 1 is a schematic diagram of the structure of a movable platform implementing the control method consistent with the present disclosure.

As shown in FIG. 1, the movable platform 100 includes a platform body 110, a power system 120, a load 130, and a control system (not shown in FIG. 1). The platform body 110 carries a replaceable load 130 for delivering materials. The load 130 may include at least one of a screw sowing mechanism, a spraying mechanism, a material conveying mechanism, or a material dispensing mechanism. The materials may include various items to be delivered, and may be solid or liquid. Solid materials include at least one of solid fertilizer, solid feed, pollen, seeds, or solid pesticides, while liquid materials include at least one of water, liquid fertilizer, liquid feed, or liquid pesticides. The power system 120 is mounted at the platform body 110 and provides power for the movable platform 100. The movable platform 100 can be controlled by a control apparatus.

In some embodiments, the power system 120 may include one or more propellers 121, one or more motors 122 corresponding to the one or more propellers, and one or more electronic speed controllers (ESCs). The motor 122 is connected between the electronic speed controller and the propeller 121. Motor 122 and propeller 121 are mounted at the platform body 110 of the movable platform 100. The electronic speed controller receives drive signals generated by the control system and provides drive current to motor 122 according to drive signals to control the speed of motor 122. Motor 122 drives propeller 121 to rotate, thereby providing power for the movement of the movable platform 100, enabling the movable platform 100 to achieve one or more degrees of freedom of motion. In some embodiments, the movable platform 100 can rotate about one or more rotation axes. For example, these rotation axes may include a roll axis, a yaw axis, and a pitch axis. It should be understood that motor 122 can be a DC motor or an AC motor. Furthermore, motor 122 can be a brushless motor or a brushed motor.

In some embodiments, the control system includes a control apparatus and a sensing system. The sensing system measures the attitude information of the movable platform 100, i.e., the position and state information of the movable platform 100 in space, such as three-dimensional position, three-dimensional angle, three-dimensional velocity, three-dimensional acceleration, and three-dimensional angular velocity. The sensing system may include at least one of a gyroscope, an ultrasonic sensor, an electronic compass, an inertial measurement unit (IMU), a vision sensor, a global navigation satellite system (GPS), or a barometer. For example, the GPS may be a global positioning system (GPS). The control apparatus controls the movement of the movable platform 100, for example, the control apparatus can control the movement of the movable platform 100 based on the attitude information measured by the sensing system. The control apparatus can control the movable platform 100 according to pre-programmed instructions.

In some embodiments, the movable platform 100 automatically detects the load attributes of the load 130. Based on the load attributes, corresponding control parameters are determined. The load attributes include a first load attribute and a second load attribute, the first load attribute corresponding to a first control parameter, and the second load attribute corresponding to a second control parameter. The first load attribute and the second load attribute are different, and the first control parameter and the second control parameter are different. The load 130 is then controlled to deliver materials according to the determined control parameters. Embodiments of the present disclosure automatically detect the load attributes of the load 130 and determine the corresponding control parameters based on the load attributes. The movable platform 100 then controls the load 130 to deliver materials according to the determined control parameters. This eliminates the need for manual identification of the load attributes of the load 130, avoiding operational accidents caused by user forgetfulness or operational errors. This greatly improves the operational accuracy and safety of the movable platform 100 and enhances the intelligence level of the movable platform 100's operation.

In some embodiments, the movable platform 100 obtains the material category of the material to be delivered. Based on the material category, the target load attributes of the load 130 are automatically determined. The target load attributes include a first target load attribute and a second target load attribute different from the first target load attribute, and the first control parameter corresponding to the first target load attribute is different from the second control parameter corresponding to the second target load attribute. The load 130 is controlled to deliver the material according to the control parameters corresponding to the target load attributes. Embodiments of the present disclosure automatically detect the material category of the material and automatically determine the target load attributes of the load 130 based on the material category, enabling the movable platform 100 to control the load 130 to deliver the material based on control parameters matching the target load attributes. This eliminates the need for manual identification of the load attributes of the load, avoiding operational accidents caused by user forgetfulness or operational errors, improving the operational accuracy and safety of the movable platform 100, and enhancing the intelligence level of the movable platform 100's operation.

The movable platform 100 may include, e.g., an aircraft or a movable robot. The aircraft may include, e.g., an unmanned aerial vehicle (UAV) or a manned aircraft. A UAV may include, e.g., a rotorcraft, such as a quadcopter, a hexacopter UAV, or an octocopter UAV, or a fixed-wing UAV, or a UAV with a combination of rotor(s) and fixed-wing(s).

The control method provided by the embodiments of the present disclosure will be described in detail below with reference to the movable platform in FIG. 1. The movable platform in FIG. 1 is only used to explain the control method provided by the embodiments of the present disclosure, but does not constitute a limitation on the application scenarios of the control method provided by the embodiments of the present disclosure.

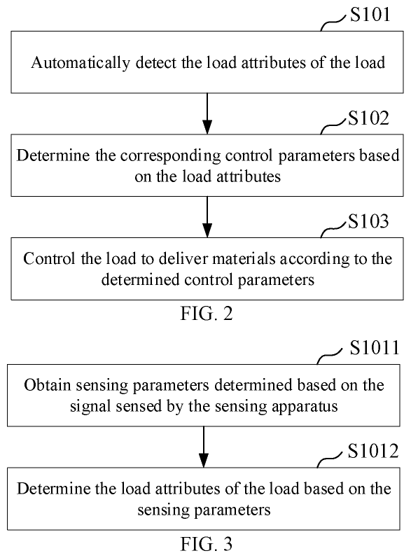

FIG. 2 is a schematic flowchart of a control method of a load of a movable platform consistent with the present disclosure. This control method can be applied to the load 130 of the movable platform 100 to improve the operational accuracy and safety of the movable platform 100.

Specifically, as shown in FIG. 2, the control method includes S101 to S103.

S101, the load attributes of the load are automatically detected.

Consistent with the present disclosure, the load may include at least one of loads of one or more different categories, loads of one or more different specifications, loads with multiple different operation configurations, or loads with multiple sub-loads. Load attributes may include at least one of load category, load specification, load operation configuration, or load combination mode. Here, the load operation configuration refers to the configuration in which a single load operates, and the load combination configuration refers to the configuration formed by multiple loads working together.

For example, the load may include a screw sowing mechanism or a spraying mechanism, and the screw sowing mechanism and the spraying mechanism belong to different categories. Another example is that the load may include multiple screw conveyors of different specifications, with different screw pitches. For example, the load may include a first screw conveyor, a second screw conveyor, and a third screw conveyor. The screw pitch of the first screw conveyor is greater than the screw pitch of the second screw conveyor, and the screw pitch of the second screw conveyor is greater than the screw pitch of the third screw conveyor.

Another example is a load including a screw conveyor, and the screw pitch of this screw conveyor is variable. By changing the screw pitch of the screw conveyor, multiple operation configurations of the screw conveyor can be obtained, and the screw pitch of the screw conveyor is different in each operation configuration. For example, the screw conveyor includes a first operation configuration, a second operation configuration, and a third operation configuration. The screw pitch of the screw conveyor in the first operation configuration is greater than the screw pitch of the screw conveyor in the second operation configuration, and the screw pitch of the screw conveyor in the second operation configuration is greater than the screw pitch of the screw conveyor in the third operation configuration.

For example, the load includes a screw conveyor, and the screw conveyor includes multiple sub screw-conveyors, the sub screw-conveyor is a segment of the screw conveyor. The sub screw-conveyors have different screw pitches. For example, the screw conveyor may include a first sub screw-conveyor, a second sub screw-conveyor, and a third sub screw-conveyor, with the first sub screw-conveyor having a larger screw pitch than the second sub screw-conveyor, and the second sub screw-conveyor having a larger screw pitch than the third sub screw-conveyor. Automatic detection of the load's load attributes can, in some embodiments, automatically detect different load attributes of the same type of load. For example, automatically detecting whether the screw conveyor is a first screw conveyor with a larger screw pitch or a second screw conveyor with a smaller screw pitch. In some embodiments, automatic detection of the load's load attributes can automatically detect load attributes of different types of loads, such as automatically detecting whether the load is a screw conveyor, a spraying mechanism, a material dispensing mechanism, or a material conveying mechanism.

In some embodiments, the load attributes are automatically detected in response to detecting that the load is installed in place on the movable platform or in response to detecting a power-on signal of the movable platform. Consistent with the present disclosure, sensors such as infrared sensors, contact sensors, or weight sensors can be used to detect whether the load is installed in place on the movable platform. The present disclosure automatically detects the load attributes upon detecting that the load is installed in place or that the movable platform is powered on, without waiting. This timely detection of load attributes facilitates subsequent control of the load for material delivery based on control parameters matching the load attributes.

In some embodiments, as shown in FIG. 3, S101 includes sub-processes S1011 to S1012.

S1011, sensing parameters determined based on the signals sensed by the sensing apparatus are obtained.

Consistent with the present disclosure, the sensing parameters may include at least one of sensing trigger time, sensing trigger frequency, or sensing signal strength. The sensing trigger time can be the interval between triggering the sensing apparatus, such as the time interval between two consecutive triggering of the sensing apparatus. The sensing trigger frequency can be the frequency at which the sensing apparatus is triggered, such as the sensing apparatus being triggered 5 times per second. The sensing signal strength can be the strength of the signals sensed by the sensing apparatus. The sensing parameters may also include other parameters, and the present disclosure does not limit on this. For example, the sensing parameters may also include the number of trigger revolutions, and the number of trigger revolutions can be the interval number of trigger revolutions of triggering the sensing apparatus.

In some embodiments, the load of the movable platform is provided with at least some components of the sensing apparatus. For example, at least one of the multiple sensors included in the sensing apparatus is provided at the load, or all of the multiple sensors included in the sensing apparatus are provided at the load. The present disclosure reduces the space occupied by the sensing apparatus at the load and the structural complexity of the load by disposing of at least some components of the sensing apparatus at the load.

In some embodiments, the load of the movable platform includes a detection chamber and a material chamber electromagnetically isolated from the detection chamber, and at least some components of the sensing apparatus are disposed in the detection chamber. The present disclosure avoids electromagnetic interference from the material in the material chamber to the at least some components of the sensing apparatus by disposing of at least some components of the sensing apparatus within the detection chamber, thereby improving the sensing accuracy of the sensing apparatus.

In some embodiments, the sensing apparatus includes a plurality of first sensors and a plurality of second sensors arranged in pairs. Consistent with the present disclosure, both the plurality of first sensors and the plurality of second sensors can be disposed at the load, or the plurality of first sensors can be disposed at the load and the plurality of second sensors at a location other than the load at the movable platform, or the plurality of second sensors can be disposed at the load and the plurality of first sensors at a location other than the load at the movable platform.

In some embodiments, the plurality of second sensors rotates with the load, while the plurality of first sensors does not. In some embodiments, the plurality of second sensors is located at a rotating part of the load, and the plurality of first sensors is located at a non-rotating part of the load or a location other than the load at the movable platform. The present disclosure, by providing the plurality of second sensors to rotate with the load and the plurality of first sensors not to rotate with the load, allows for relative rotation between the plurality of first sensors and the plurality of second sensors, facilitating the determination of the load's load attributes using the sensing parameters determined by the relative rotation between the plurality of first sensors and the plurality of second sensors.

In some embodiments, the plurality of first sensors includes a magnetic sensor for sensing magnetic signals, such as a Hall sensor, and the plurality of second sensors includes a magnetic element for generating magnetic signals, such as a magnet. In this case, the magnetic element can be disposed at the load, and the magnetic sensor can be disposed at a location other than the load at the movable platform. The present disclosure uses a combination of magnetic sensors and magnetic components to detect the load attributes, offering advantages such as low cost and easy scalability.

In some embodiments, the load of the movable platform includes a screw conveyor. The number of first sensors and/or the plurality of second sensors disposed at the screw conveyor is negatively correlated with the screw conveyor's screw pitch. That is, the smaller the screw conveyor's screw pitch, the more first sensor and/or the plurality of second sensors are disposed at the screw conveyor; the larger the screw conveyor's screw pitch, the fewer first sensor and/or the plurality of second sensors are disposed at the screw conveyor. The present disclosure uses different numbers of first sensor and/or the plurality of second sensors on screw conveyors with different screw pitches, facilitating the identification of screw conveyors with different screw pitches based on the sensed different sensing parameters.

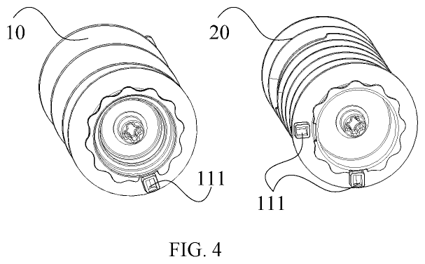

For example, the number of magnets on a screw conveyor is negatively correlated with the screw pitch of the screw conveyor; that is, the larger the screw pitch, the fewer magnets are disposed at the screw conveyor, and the smaller the screw pitch, the more magnets are disposed at the screw conveyor. As shown in FIG. 4, the screw pitch of the first screw conveyor 10 is greater than the screw pitch of the second screw conveyor 20, and the first screw conveyor 10 has one magnet 111, while the second screw conveyor 20 has two magnets 111.

In some embodiments, multiple first sensor and/or the plurality of second sensors of the screw conveyor are arranged at intervals along the circumference of the screw conveyor. The spacing between adjacent sensors on screw conveyors with different screw pitches varies. Consistent with the present disclosure, multiple first sensor and/or the plurality of second sensors are arranged at different intervals on screw conveyors with different screw pitches, this arrangement facilitates the identification of screw conveyors with different screw pitches based on the different sensing parameters sensed.

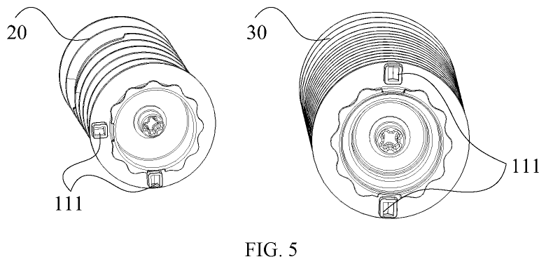

For example, the spacing between two adjacent magnets on screw conveyors with different screw pitches is different. As shown in FIG. 5, the screw pitch of the second screw conveyor 20 is different from the screw pitch of the third screw conveyor 30, and the screw pitch of the second screw conveyor 20 is greater than the screw pitch of the third screw conveyor 30. The spacing between two magnets 111 on the second screw conveyor 20 is half a circumference, while the spacing between two magnets 111 on the third screw conveyor 30 is ¼ or ¾ of a circumference. In other words, the spacing between two magnets 111 on the second screw conveyor 20 is different from the spacing between two magnets 111 on the third screw conveyor 30.

In some embodiments, the number of the plurality of first sensors and/or the plurality of second sensors of the magnets disposed at the screw conveyor are negatively correlated with the screw pitch of the screw conveyor. Multiple first sensor and/or the plurality of second sensors disposed at the screw conveyor are arranged at intervals along the circumference of the screw conveyor, and the spacing between adjacent sensors differs for screw conveyors with different screw pitches. The present disclosure facilitates the identification of screw conveyors with different screw pitches by providing different numbers of first sensor and/or the plurality of second sensors on screw conveyors with different screw pitches and by providing multiple first sensor and/or the plurality of second sensors at different intervals on screw conveyors with different screw pitches, thus enabling the identification of screw conveyors with different screw pitches based on the different sensing parameters sensed.

In some embodiments, the distance between the plurality of first sensors and the plurality of second sensors changes with the rotation of the screw conveyor. When the screw conveyor is at the target position, the screw conveyor can prevent material leakage, and the distance between the plurality of first sensors and the plurality of second sensors is the shortest. The present disclosure, by providing a plurality of first sensors and/or a plurality of second sensors on the screw conveyor, ensures that the screw conveyor can prevent material leakage when the screw conveyor is at the target position, and the distance between the plurality of first sensors and the plurality of second sensors is the shortest. Thus, the sensing parameters determined based on the signals sensed by the sensing apparatus can accurately control the screw conveyor to stop at the target position to prevent material leakage, effectively preventing material leakage caused by the screw conveyor's own structure.

For example, screw conveyor with larger screw pitches have larger gaps between screw conveyor and the outer casing, and material leakage is more likely to happen. To prevent material leakage, a baffle structure is installed at the end of the screw conveyor. A magnet is disposed at the screw conveyor, and a Hall sensor is installed outside the screw conveyor. This ensures that when the screw conveyor is at the target position, the screw conveyor can prevent material leakage, and the distance between the magnet and the Hall sensor is the shortest. The sensing parameters determined by the magnetic signals sensed by the Hall sensor can accurately control the screw conveyor to stop at the target position, effectively preventing material leakage caused by the screw conveyor's own structure.

In some embodiments, in response to a stop rotation instruction from the screw conveyor, if the screw pitch of the screw conveyor is greater than a preset screw pitch, the screw conveyor is controlled to stop rotating when the sensing parameters determined by the sensing signal from the sensing apparatus meet the preset parameter conditions. After the screw conveyor stops rotating, the screw conveyor is at a target position. The preset parameter conditions include at least one of preset sensing trigger time, preset sensing trigger frequency, preset sensing signal strength, or preset number of sensing trigger revolutions. The preset sensing trigger time, preset sensing trigger frequency, preset sensing signal strength, and preset number of sensing trigger revolutions can be set based on actual conditions, and the present disclosure does not specifically limit them. For example, the preset number of sensing trigger revolutions is 1.

In some embodiments, the load includes the screw conveyor. Obtaining the sensing parameters determined by the sensing signal from the sensing apparatus may include: controlling the screw conveyor to rotate at a preset rotation speed in response to detecting that the load is installed in place on the movable platform or in response to detecting a power-on signal from the movable platform; and obtaining the sensing parameters determined by the sensing signal from the sensing apparatus each time the screw conveyor rotates to the preset number of revolutions. The preset rotation speed and preset number of revolutions can be set based on actual conditions, and the present disclosure does not specifically limit this. The present disclosure controls the screw conveyor to rotate at a preset rotation speed when the load is detected to be installed in place or when the movable platform is powered on, and each time the screw conveyor reaches the preset number of revolutions, the sensing parameters determined based on the signals sensed by the sensing apparatus are obtained, thus ensuring the accuracy of the sensing parameters.

S1012, the load attributes of the load are determined based on the sensing parameters.

The present disclosure, by providing at least some components of the sensing apparatus at the load, enables the movable platform to accurately determine the load attributes based on the sensing parameters determined based on the signals sensed by the sensing apparatus. This allows the movable platform to control the load for material delivery based on control parameters matching the load attributes, eliminating the need for manual identification of the load attributes and preventing operational accidents due to user forgetfulness or operational errors. This greatly improves the operational accuracy and safety of the movable platform and enhances intelligence level of operation.

In some embodiments, determining the load attributes of a load based on sensing parameters determined based on the signals sensed by the sensing apparatus may include: determining the load attributes of the load based on the sensing parameters determined based on the signals sensed by the sensing apparatus and a preset mapping relationship between the sensing parameters and load attributes. The present disclosure can accurately and quickly determine the load attributes of a load by using the mapping relationship between the sensing parameters and load attributes, and the sensing parameters determined based on the signals sensed by the sensing apparatus.

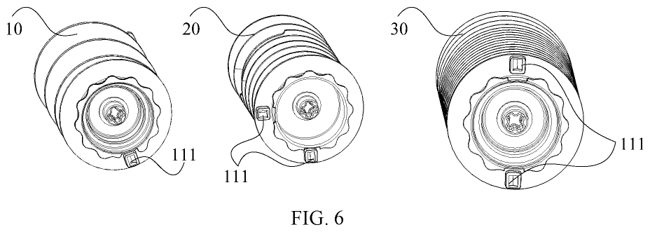

In some embodiments, the preset mapping relationship between the sensing parameters and load attributes is established in advance based on the number and/or location of at least some components of the sensing apparatus provided at the load. For example, as shown in FIG. 6, the screw pitch of the first screw conveyor 10 is greater than the screw pitch of the second screw conveyor 20, and the screw pitch of the second screw conveyor 20 is greater than the screw pitch of the third screw conveyor 30. The first screw conveyor 10 has one magnet 111, the second screw conveyor 20 has two magnets 111, and the distance between the two magnets 111 is ¼ or ¾ of a circumference. The third screw conveyor 30 has two magnets 111, and the distance between the two magnets 111 is ½ of a circumference. Based on the above, a mapping relationship can be established between the number of trigger revolutions of the Hall sensor and the specifications of the screw conveyors. This mapping relationship is shown in Table 1 below.

TABLE 1

| Number of | | | |
|---|---|---|---|
| Induction | Upper | Lower Limit | |
| Trigger | Limit Error | Error | Screw Conveyor |
| Revolutions | (Revolutions) | (Revolutions) | Specification |
| 0.25 | 0.1 | 0.1 | Third Screw Conveyor |
| 0.5 | 0.1 | 0.1 | Second Screw Conveyor |
| 0.75 | 0.1 | 0.1 | Third Screw Conveyor |
| 1.0 | 0.1 | 0.1 | First Screw Conveyor |

The upper and lower limit errors refer to the number of tolerable error revolutions based on the expected number of induction trigger revolutions. For example, if the number of induction trigger revolutions is in the range of 0.15 to 0.35, then the screw conveyor installed on the movable platform can be identified as the third screw conveyor; if the number of induction trigger revolutions is in the range of 0.4 to 0.6, then the screw conveyor installed on the movable platform can be identified as the second screw conveyor; and if the number of induction trigger revolutions is in the range of 0.9 to 1.1, then the screw conveyor installed on the movable platform can be identified as the first screw conveyor. The upper and lower limit errors in Table 1 can be set based on actual conditions, and the present disclosure does not specifically limit this.

In some embodiments, if the load attributes corresponding to the sensing parameters determined by the sensing apparatus's signal are not found according to the preset mapping relationship between sensing parameters and load attributes, a preset alarm message is output or the process returns to S101 to automatically detect the load attribute. The preset alarm message is configured to prompt the user that the load installed on the movable platform cannot be identified, and the user needs to check whether the installed load is correct. The present disclosure outputs alarm message when the load attributes cannot be automatically detected, allowing users to promptly check whether the installed load is correct, and improving the user experience.

In some embodiments, the load includes an RFID tag. Automatic detection of the load attributes may include: determining the load attributes based on the RFID tag. The RFID tag is configured to store the load attributes of the load. The present disclosure, by providing an RFID tag storing load attributes on the load, enables the movable platform to quickly and conveniently identify the load attributes based on the RFID tag. Furthermore, the RFID tag is low-cost and easily scalable. However, RFID tag detection has certain application limitations; the accuracy of detection using RFID tag is easily affected by signal interference from the built-in electrical components of the movable platform.

S102, the corresponding control parameters are determined based on the load attributes.

Consistent with the present disclosure, the control parameters are used to control the load to deliver materials. The determined load attributes may include a first load attribute and a second load attribute different from the first load attribute. The first control parameter corresponding to the first load attribute is different from the second control parameter corresponding to the second load attribute. The first load attribute may include at least one of load category, load specification, load operation configuration, or load combination configuration. The second load attribute may also include at least one of load category, load specification, load operation configuration, or load combination configuration. For example, the first load attribute is a screw conveyor, and the second load attribute includes at least one of specification, operation configuration, or combination configuration of the screw conveyor.

In some embodiments, the load includes a material conveying mechanism, and the control parameters include at least one of conveying control parameters or a first motion control parameter of the movable platform. The first motion control parameter may include motion speed, motion acceleration, motion height, etc. The load includes a material dispensing mechanism, and the control parameters include at least one of a dispensing control parameter or a second motion control parameter of the movable platform. The second motion control parameter may include motion speed, motion acceleration, motion height, etc.

In some embodiments, the load includes a screw conveyor, and the control parameters include sowing control parameters and/or a third motion control parameter of the movable platform. The sowing control parameters may include minimum rotation speed, maximum rotation speed, feed flow rate, and discharge flow rate. The third motion control parameter of the movable platform is related to the sowing width and may include the movable platform's motion speed and motion height, etc. Taking an agricultural unmanned vehicle (UV) as an example, the first motion control parameters include the UV's first flight altitude and first flight speed. During the process of controlling the screw conveyor to spread materials according to the determined control parameters, the agricultural UV flies at the first flight altitude and first flight speed.

In some embodiments, the load includes a spraying mechanism, and the control parameters include spraying control parameters and/or a fourth motion control parameter of the movable platform. The spraying control parameters may include spraying particle size, spraying flow rate, spraying velocity, spraying rotation speed, etc. The fourth motion control parameter of the movable platform is related to the spraying amplitude and spraying pressure. Taking an agricultural UV as an example, the second motion control parameters include the UV's second flight altitude and second flight speed. During the process of controlling the spraying mechanism to spray materials according to the determined control parameters, the UV flies at the second flight altitude and second flight speed.

In some embodiments, the load includes a material conveying mechanism and/or a material dispensing mechanism, and the control parameters include at least one of conveying speed, conveying flow rate, dispensing speed, or dispensing flow rate.

In some embodiments, determining the corresponding control parameters based on load attributes may include: automatically configuring the corresponding control parameters based on the load attributes and a preset mapping relationship between load attributes and control parameters. The present disclosure automatically configures control parameters matching the load attributes of the load by using a preset mapping relationship between load attributes and control parameters, greatly improving the accuracy and efficiency of control parameter configuration.

The mapping relationship between load attributes and control parameters is preset according to actual conditions, and the present disclosure does not specifically limit it. For example, the mapping relationship between the specifications of the screw conveyor and the control parameters can be shown in Table 2 below.

TABLE 2

| Screw Conveyor | Sowing control | |
|---|---|---|
| Specification | parameter | Sowing Width |
| First Screw Conveyor | 50-350 rpm | 6 m, with 2 m inward |
| | | sweeping at the edge |
| Second Screw Conveyor | 50-500 rpm | 6 m, with 2 m inward |
| | | sweeping at the edge |
| Third Screw Conveyor | 75-450 rpm | 5 m, with 2 m inward |
| | | sweeping at the edge |

The screw pitch of the first screw conveyor is greater than the screw pitch of the second screw conveyor, and the screw pitch of the second screw conveyor is greater than the screw pitch of the third screw conveyor. The sowing control parameters in Table 2 refer to the rotational speed range of the screw conveyors.

In some embodiments, determining the corresponding control parameters based on load attributes may include: obtaining the material category of the material; automatically configuring the corresponding control parameters based on the load attributes, material category, and a preset mapping relationship between load attributes, material category, and control parameters. The present disclosure automatically configures control parameters that match the load attributes and material categories by a preset mapping relationship between load attributes, material categories, and control parameters. This ensures that the configured control parameters better meet the needs of the load and materials, greatly improving the accuracy and efficiency of control parameter configuration.

The mapping relationship between load attributes, material categories, and control parameters is preset based on actual conditions, and the present disclosure does not impose specific limitations on this. For example, the mapping relationship between screw conveyor specifications, material categories, and control parameters can be shown in Table 3 below, and the sowing control parameters in Table 3 represent the rotational speed range of the screw conveyor.

TABLE 3

| Screw | | Sowing | |
|---|---|---|---|
| Conveyor | Material | control | |
| Specification | Category | Parameter | Sowing Width |
| First Screw | Urea; Compound | 50-500 rpm | 8 m, with 3 m inward |
| Conveyor | Fertilizer | | sweeping at the edge |
| First Screw | Rice; Grass | 50-350 rpm | 6 m, with 2 m inward |
| Conveyor | Seed | | sweeping at the edge |
| Second Screw | Rice | 50-500 rpm | 6 m, with 2 m inward |
| Conveyor | | | sweeping at the edge |
| Third Screw | Rapeseed | 75-450 rpm | 5 m, with 2 m inward |
| Conveyor | | | sweeping at the edge |
| Third Screw | Solid | 75-450 rpm | 5 m, with 2 m inward |
| Conveyor | Herbicide | | sweeping at the edge |

In some embodiments, after S102, the method further includes: outputting parameter configuration prompt message corresponding to the control parameters. This parameter configuration prompt message is configured to prompt the user to configure the control parameters or to automatically configure the control parameters. The present disclosure, after the control parameters are determined, prompts the user to configure the control parameters or automatically configures the control parameters, enabling the movable platform to control the load for material delivery according to the control parameters matching the load attributes. This eliminates the need for manual identification of the load attributes of the load, preventing operational accidents due to user forgetfulness or operational errors, and greatly improving the operational accuracy and safety of the movable platform.

S103, the load is controlled to deliver materials according to the determined control parameters.

The present disclosure automatically detects the load attributes and determines the corresponding control parameters the load attributes. The movable platform then controls the load to deliver materials according to the determined control parameters. This eliminates the need for manual identification of the load attributes of the load, preventing operational accidents due to user forgetfulness or operational errors, and greatly improving the operational accuracy and safety of the movable platform.

In some embodiments, controlling the load to deliver materials according to the determined control parameters may include at least one of the following: adjusting the power parameters of the movable platform to achieve the determined control parameters; adjusting the power parameters of the load to achieve the determined control parameters; adjusting the configurations of the load to achieve the determined control parameters; or replacing the load's components to achieve the determined control parameters. The power parameters of the movable platform can include the moving speed and moving acceleration of the movable platform. When the movable platform is an aircraft, the power parameters can include the flight speed and flight altitude of the aircraft. The power parameters of the load can include rotational speed and moving speed of the load.

For example, the determined control parameters include the feed rate and sowing width of the screw conveyor. Taking an agricultural UV as an example, the sowing width is related to the UV's flight altitude and flight speed, while the feed rate of the screw conveyor is related to the rotational speed of the screw conveyor. If the screw conveyor installed on the agricultural UV can achieve a determined feed rate, the UV controls the screw conveyor to rotate at the speed corresponding to the determined feed rate, ensuring the determined feed rate is achieved. Furthermore, the UV flies at the flight altitude and flight speed corresponding to the defined sowing width, ensuring the determined sowing width is achieved.

For example, if the performance of the screw conveyor already installed on the agricultural UV is insufficient to achieve the determined feed flow rate, the agricultural UV will replace the installed screw conveyor with a screw conveyor that can achieve the determined feed flow rate. After replacement, the screw conveyor will be controlled to rotate at the speed corresponding to the determined feed flow rate, so that the determined feed flow rate can be achieved.

As another example, if the current configuration of the screw conveyor already installed on the agricultural UV is insufficient to achieve the determined feed flow rate, the agricultural UV can adjust the configuration of the installed screw conveyor to a target configuration that can achieve the determined feed flow rate. After adjustment, the screw conveyor will be controlled to rotate at the speed corresponding to the determined feed flow rate, so that the determined feed flow rate can be achieved.

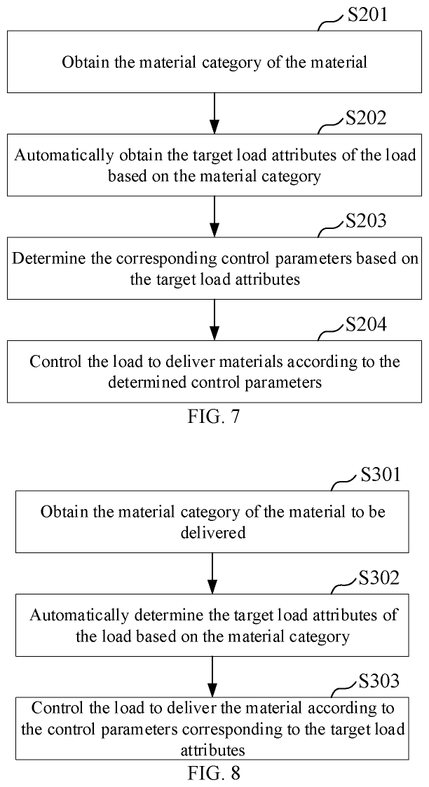

FIG. 7 is a schematic flowchart of another control method for the load of a movable platform consistent with the present disclosure.

Specifically, as shown in FIG. 7, this control method includes S201 to S204.

S201, the material category of the material is obtained.

Consistent with the present disclosure, the material category may include urea, compound fertilizer, solid herbicide, rice, rapeseed, grass seed, wheat, corn, or soybean, etc.

In some embodiments, the material category is automatically obtained in response to detecting that the load is installed in place on the movable platform or in response to detecting a power-on signal of the movable platform. This can be achieved using sensors such as infrared sensors, contact sensors, or weight sensors to detect whether the load is installed in place on the movable platform. The present disclosure automatically obtains the material category when the load is detected to be installed in place or when the movable platform is powered on, eliminating the need for waiting. This timely detection of the material category facilitates subsequent determination of the load's load attributes based on the material category.

In some embodiments, obtaining the material category of the material may include: obtaining a target image containing the material; and determining the material category based on the semantic information of the target image. The present disclosure can automatically and accurately identify the material category by using the semantic information of the target image containing the material. In some embodiments, the material category can be manually entered by the user.

In some embodiments, determining the material category based on the semantic information of the target image may include: identifying the material category of the target image using a preset material category recognition model. The material category recognition model is pre-trained on a preset neural network model based on multiple training samples, including sample images and material categories.

S202, the target load attributes of the load are automatically obtained based on the material category.

Consistent with the present disclosure, the target load attributes may include at least one of the following: load category, load specification, load operation configuration, or load combination configuration. Load category refers to the type of load, such as a screw sowing mechanism or a spraying mechanism, and the screw sowing mechanism and the spraying mechanism belong to different categories. Load specification refers to the size or screw pitch of the load, etc. Load operation configuration refers to the configuration when a single load is working, and load combination configuration refers to the configuration formed by multiple loads working together.

In some embodiments, automatically obtaining the target load attributes of the load based on the material category may include: automatically obtaining the target load attributes of the load based on the material category and a preset mapping relationship between material categories and load attributes. The present disclosure can automatically determine the target load attributes of a load based on the material category and a preset mapping relationship between material categories and load attributes, even when no load is installed on the movable platform. The present disclosure can quickly and accurately determine the target load attributes of a load by using the mapping relationship between material categories and load attributes, as well as the identified material categories.

The preset mapping relationship between material categories and target load attributes can be set based on actual conditions, and the present disclosure does not specifically limit this. For example, the mapping relationship between material categories and screw conveyor specifications can be shown in Table 4 below.

TABLE 4

| Screw Conveyor Specification | Material Category |
|---|---|
| First Screw Conveyor | Urea; Compound Fertilizer |
| First Screw Conveyor | Rice; Grass Seed |
| Second Screw Conveyor | Rice |
| Third Screw Conveyor | Rapeseed |
| Third Screw Conveyor | Solid Herbicide |

The screw pitch of the first screw conveyor is greater than the screw pitch of the second screw conveyor, and the screw pitch of the second screw conveyor is greater than the screw pitch of the third screw conveyor.

In some embodiments, automatically obtaining the target load attributes of the load based on the material category may include at least one of the following: selecting at least one load matching the material category from multiple different loads as the target load attributes; selecting at least one sub-load matching the material category from multiple different sub-loads of the load as the target load attributes; selecting at least one load operation configuration matching the material category from multiple different load operation configurations of the load as the target load attributes; or determining a load combination formed by configuring different cooperation modes between multiple loads based on the material category as the target load attributes. The cooperation mode between multiple loads may include multiple loads connected in parallel for material delivery or multiple loads connected in series for material delivery.

Taking a screw conveyor as an example, in some embodiments, the screw pitch of the screw conveyor is variable. For example, in some cases, such as on the shaft or housing of the screw conveyor, there are retractable tweezers that are sometimes retracted (resulting in a larger screw pitch) and sometimes extended (resulting in a smaller screw pitch). In some embodiments, the variable operation configuration can be caused by variables such as variable blade size, variable blade installation angle, and variable shaft size of the screw conveyor. As long as different operating scenarios and/or different delivering materials can be adapted to, variable operation configuration falls within the scope of the load operation configuration of the present disclosure and is not limited here.

For example, the load includes a first screw conveyor, a second screw conveyor, and a third screw conveyor, with the screw pitch of the first screw conveyor being greater than the screw pitch of the second screw conveyor, and the screw pitch of the second screw conveyor being greater than the screw pitch of the third screw conveyor. If the material to be sown is rapeseed, then according to the mapping relationship between material categories and screw conveyor specifications described in Table 4, the third screw conveyor matching the rapeseed is selected as the target load attributes.

As another example, the load includes a first sub screw-conveyor, a second sub screw-conveyor, and a third sub screw-conveyor. The screw pitch of the first sub screw-conveyor is greater than the screw pitch of the second sub screw-conveyor, and the screw pitch of the second sub screw-conveyor is greater than the screw pitch of the third sub screw-conveyor. If the material to be sown is rice, then according to the mapping relationship between material categories and screw conveyor specifications described in Table 5, the first and second sub screw-conveyors matched to the rice should be selected as the target load attributes.

TABLE 5

| Material Category | Screw Conveyor Specification |
|---|---|
| Urea; Compound Fertilizer | First Sub-screw Conveyor |
| Rice; Grass Seed | First Sub-screw Conveyor |
| Rice | Second Sub-screw Conveyor |
| Rapeseed | Third Sub-screw Conveyor |
| Solid Herbicide | Third Sub-screw Conveyor |

As another example, the load includes a screw conveyor having three operation configurations: a first operation configuration, a second operation configuration, and a third operation configuration. The screw pitch of the screw conveyor in the first operation configuration is greater than the screw pitch of the screw conveyor in the second operation configuration, and the screw pitch the screw conveyor in the second operation configuration is greater than the screw pitch of the screw conveyor in the third operation configuration. If the material to be sown is urea, then according to the mapping relationship between material categories and screw conveyor operation configurations described in Table 6, the first operation configuration matching urea is selected as the target load attributes.

TABLE 6

| Material Category | Operation configuration of Screw Conveyor |
|---|---|
| Urea; Compound Fertilizer | First Operation configuration |
| Rice; Grass Seed | First Operation configuration |
| Rice | Second Operation configuration |
| Rapeseed | Third Operation configuration |
| Solid Herbicide | Third Operation configuration |

In some embodiments, after S202, the method further includes: if the movable platform is not equipped with a load, outputting first information. The first information is configured to prompt the user to install a load with the target load attributes. In some embodiments, if the movable platform is not equipped with a load, outputting a first instruction. The first instruction is configured to instruct the movable platform to automatically install a load with the target load attributes. The present disclosure, by prompting the user to install a load with the target load attributes or automatically installing a load with the target load attributes when the movable platform is not equipped with a load, ensures that the load attributes of the installed load meet the needs of the material category, avoiding the use of loads that do not meet the needs of the material category for material delivery, and improving the operational safety of the movable platform.

For example, the loads that can be installed on the movable platform include a first screw conveyor, a second screw conveyor, and a third screw conveyor, with the screw pitch of the first screw conveyor is greater than the screw pitch of the second screw conveyor, and the screw pitch of the second screw conveyor is greater than the screw pitch of the third screw conveyor. For example, if the target load attributes include the first screw conveyor, and the movable platform does not have a load installed, the user will be prompted to install the first screw conveyor or the movable platform automatically will be prompted to automatically install the first screw conveyor. Similarly, if the target load attributes include the second screw conveyor, and the movable platform does not have a load installed, the user will be prompted to manually install the second screw conveyor or the movable platform will be prompted to automatically install the second screw conveyor.

In some embodiments, after S202, the method further includes: if the current load attributes of the load already installed on the movable platform are not the target load attributes, then outputting second information. The second information is configured to prompt the user to change the load. In some embodiments, if the current load attributes of the load already installed on the movable platform are not the target load attributes, then outputting a second instruction. The second instruction is configured to instruct the movable platform to automatically switch to a load with the target load attributes. The present disclosure prompts the user to replace the load or automatically switches to a load with the target load attributes when the current load attributes of the load already installed on the movable platform differ from the target load attributes. This ensures that the replaced or switched load attributes meet the material category needs, preventing the use of loads that do not meet the material category needs for material delivery and improving the operational safety of the movable platform.

For example, the movable platform can be equipped with loads including a first screw conveyor, a second screw conveyor, and a third screw conveyor, with the screw pitch of the first screw conveyor is greater than the screw pitch of the second screw conveyor, and the screw pitch of the second screw conveyor is greater than the screw pitch of the third screw conveyor. If the movable platform is currently equipped with a first screw conveyor, and the target load attributes include a third screw conveyor, the user can be prompted to replace the currently installed first screw conveyor on the movable platform with the third screw conveyor.

As another example, the movable platform has installed a screw conveyor with three operation configurations: a first operation configuration, a second operation configuration, and a third operation configuration. The installed screw conveyor is currently in the first operation configuration, while the target load attributes are the second operation configuration of the screw conveyor. In this case, the movable platform can automatically switch the screw conveyor's operation configuration from the first operation configuration to the second operation configuration, or prompt the user to manually switch the screw conveyor's operation configuration from the first operation configuration to the second operation configuration.

As another example, the installed load on the movable platform includes a first sub screw-conveyor, a second sub screw-conveyor, and a third sub screw-conveyor. The installed screw conveyor is currently using the second sub screw-conveyor, while the target load attributes include the third sub screw-conveyor. In this case, the movable platform can automatically switch the second sub screw-conveyor to the third sub screw-conveyor, or prompt the user to manually switch the second sub screw-conveyor to the third sub screw-conveyor.

S203, the corresponding control parameters are determined based on the target load attributes.

Consistent with the present disclosure, the target load attributes include a first target load attribute and a second target load attribute different from the first target load attribute. The first control parameter corresponding to the first target load attribute is different from the second control parameter corresponding to the second target load attribute. The first target load attribute may include at least one of load category, load specification, load operation configuration, or load combination configuration. The second target load attribute may include at least one of load category, load specification, load operation configuration, or load combination configuration. For example, the first target load attribute is a screw conveyor, and the second target load attribute includes at least one of specification, operation configuration, or combination configuration of the screw conveyor.

In some embodiments, determining the corresponding control parameter based on the target load attributes may include: automatically configuring the corresponding control parameters according to the target load attributes and a preset mapping relationship between load attributes and control parameters. The present disclosure automatically configures control parameters matching the target load attributes of the load through a preset mapping relationship between load attributes and control parameters, greatly improving the accuracy and efficiency of control parameter configuration.

S204, the load is controlled to deliver materials according to the determined control parameters.

The present disclosure obtains the material category of the material and automatically determines the target load attributes of the load based on the material category. Then, based on the target load attributes, the present disclosure determines the corresponding control parameters, and the movable platform controls the load to deliver the material according to the determined control parameters. This eliminates the need for manual identification of the load attributes of the load, thus avoiding operational accidents caused by user forgetfulness or operational errors, and greatly improving the operational accuracy and safety of the movable platform.

In some embodiments, controlling the load to deliver the material according to the determined control parameters may include at least one of the following: adjusting the power parameters of the movable platform to achieve the determined control parameters; adjusting the power parameters of the load to achieve the determined control parameters; adjusting the configurations of the load to achieve the determined control parameters; or replacing the load's components to achieve the determined control parameters. The power parameters of the movable platform may include the platform's moving speed, moving acceleration, etc. When the movable platform is an aircraft, the power parameters may include the aircraft's flight speed, flight altitude, etc. The power parameters of the load may include the load's rotation speed, moving speed, etc.

FIG. 8 is a schematic flowchart of another control method of the load of the movable platform consistent with the present disclosure.

Specifically, as shown in FIG. 8, the control method includes S301 to S303.

S301, the material category of the material to be delivered is obtained.

For example, the material category of the material to be delivered may include urea, compound fertilizer, solid herbicide, rice, rapeseed, grass seed, wheat, corn, or soybeans, etc. The material to be delivered is also referred to as a “target material.”

In some embodiments, the material category of the material to be delivered is automatically obtained in response to detecting that the load is installed in place on the movable platform or in response to detecting a power-on signal of the movable platform. This can be achieved using sensors such as infrared sensors, contact sensors, or weight sensors to detect whether the load is installed in place on the movable platform. The present disclosure automatically obtains the material category of the material to be delivered when the load is detected to be installed in place or when a power-on signal of the movable platform is detected, eliminating the need for waiting. This allows for timely detection of the material category, facilitating subsequent determination of the load's load attributes based on the material category.

In some embodiments, obtaining the material category of the material to be delivered may include: obtaining a target image containing the material to be delivered; and determining the material category of the material to be delivered based on the semantic information of the target image. The present disclosure can automatically and accurately identify the material category of the material to be delivered by using semantic information from the target image containing the material. In some embodiments, the material category can be manually input by the user. In some embodiments, a camera can be added to the material bin or a camera on a movable platform can be reused to identify the material category in the bin in real time.

In some embodiments, determining the material category of the material to be delivered based on the semantic information of the target image may include: performing material category recognition on the target image using a preset material category recognition model to obtain the material category of the material to be delivered. This material category recognition model is pre-trained on a preset neural network model using multiple training samples, including sample images and material categories.

S302, the target load attributes of the load are automatically determined based on the material category.

Consistent with the present disclosure, the load is configured to deliver materials. The target load attributes include a first target load attribute and a second target load attribute different from the first target load attribute. The first control parameter corresponding to the first target load attribute is different from the second control parameter corresponding to the second target load attribute.

In some embodiments, automatically determining the target load attributes of a load based on the material category may include: automatically determining the target load attributes of the load based on the material category and a preset mapping relationship between material categories and load attributes. This can be achieved even when no load is installed on the movable platform, by automatically determining the target load attributes of the load based on the material category and the preset mapping relationship between material categories and load attributes. The present disclosure can quickly and accurately determine the target load attributes of the load by using the mapping relationship between material categories and load attributes and the identified material category.

In some embodiments, automatically determining the target load attributes of a load based on the material category includes at least one of the following: designating at least one load from a plurality of different loads that matches the material category as the target load attributes; selecting at least one sub-load from a plurality of different sub-loads of the load that matches the material category as the target load attributes; selecting at least one load operation configuration from a plurality of different load operation configurations of the load that matches the material category as the target load attributes; or determining a load combination formed by configuring different cooperation modes between multiple loads based on the material category as the target load attributes.

In some embodiments, after S302, the method further includes: if no load is installed on the movable platform, outputting first information. The first information is configured to prompt the user to install a load with the target load attributes. In some embodiments, if the movable platform is not equipped with a load, a first instruction is output. The first instruction instructs the movable platform to automatically install a load with the target load attributes. The present disclosure, by prompting the user to install a load with the target load attributes or automatically installing a load with the target load attributes when the movable platform is not equipped with a load, ensures that the load attributes of the installed load meet the needs of the material category, avoiding the use of loads that do not meet the material category needs for material delivery, and improving the operational safety of the movable platform.

In some embodiments, after S302, the method further includes: if the current load attributes of the load already installed on the movable platform are not the target load attributes, outputting second information. The second information instructs the user to change the load. In some embodiments, if the current load attributes of the load already installed on the movable platform are not the target load attributes, outputting a second instruction. The second instruction instructs the movable platform to automatically switch to a load with the target load attributes. The present disclosure prompts the user to change the load or automatically switches to a load with the target load attributes when the current load attributes of the load installed on the movable platform differ from the target load attributes. This ensures that the load attributes of the changed or switched load meet the material category needs, avoiding the use of loads that do not meet the material category needs for material delivery and improving the operational safety of the movable platform.

S303, the load is controlled to deliver the material according to the control parameters corresponding to the target load attributes.

The present disclosure obtains the material category of the material to be delivered and automatically determines the target load attributes of the load based on the material category. Then, the movable platform controls the load to deliver the material based on the control parameters matching the target load attributes. This eliminates the need for manual identification of the load attributes of the load, preventing operational accidents caused by user forgetfulness or operational errors, and greatly improving the operational accuracy and safety of the movable platform.

In some embodiments, controlling the load to deliver materials according to control parameters corresponding to the target load attributes may include at least one of the following: adjusting the power parameters of the movable platform to achieve the control parameters corresponding to the target load attributes; adjusting the power parameters of the load to achieve the control parameters corresponding to the target load attributes; adjusting the configurations of the load to achieve the control parameters corresponding to the target load attributes; or replacing the load's components to achieve the control parameters corresponding to the target load attributes.

For example, control parameters corresponding to the target load attributes include the feed flow rate and sowing width of the screw conveyor. Taking an agricultural UV as an example, the sowing width is related to the UV's flight altitude and flight speed, while the feed flow rate of the screw conveyor is related to the rotational speed of the screw conveyor. If the performance of the screw conveyor installed on the agricultural UV can achieve the feed flow rate corresponding to the target load attributes, then the agricultural UV controls the screw conveyor to rotate at a rotational speed matched to the feed flow rate corresponding to the target load attributes, ensuring that the feed flow rate reaches the feed flow rate corresponding to the target load attributes. Furthermore, the agricultural UV flies at a flight altitude and flight speed matched to the sowing width corresponding to the target load attributes, ensuring that the sowing width of the screw conveyor reaches the determined sowing width corresponding to the target load attributes.

As another example, if the performance of the screw conveyor already installed on an agricultural UV cannot reach the feed flow rate corresponding to the target load attributes, the agricultural UV will replace the installed screw conveyor with a screw conveyor whose performance can achieve the feed flow rate corresponding to the target load attributes. After replacement, the screw conveyor will be controlled to rotate at a rotational speed matched to the feed flow rate corresponding to the target load attributes, so that the feed flow rate of the screw conveyor can reach the determined feed flow rate corresponding to the target load attributes.

As another example: if the performance of the screw conveyor installed on the agricultural UV cannot achieve the feed flow rate corresponding to the target load attributes, the agricultural UV can adjust the configuration of the installed screw conveyor to a target configuration that can achieve the feed flow rate corresponding to the target load attributes. After adjustment, the screw conveyor is controlled to rotate at a rotational speed matching the feed flow rate corresponding to the target load attributes, thus ensuring the feed flow rate reaches the feed flow rate corresponding to the target load attributes.

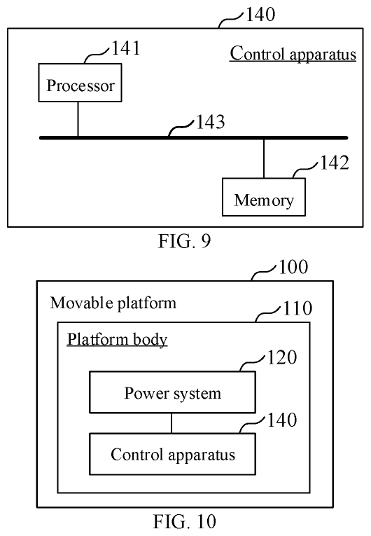

FIG. 9 is a schematic structural diagram of a control apparatus consistent with the present disclosure.

As shown in FIG. 9, the control apparatus 140 includes a processor 141 and a memory 142, connected via a bus 143, such as an I2C (Inter-integrated Circuit) bus. The control apparatus 140 is configured to control the load of a movable platform to deliver materials.

Specifically, the processor 141 can be a microcontroller unit (MCU), a central processing unit (CPU), or a digital signal processor (DSP), etc.

Specifically, the memory 142 can be a Flash chip, a read-only memory (ROM) disk, an optical disk, a USB flash drive, or a portable hard drive, etc.

The processor 141 is configured to execute a computer program stored in the memory 142, and when executing the computer program, performs the following processes:
automatically detect the load attributes of the load. The load is configured to deliver materials;
determine corresponding control parameters based on the load attributes. The control parameters are configured to control the load to deliver the materials, the load attributes include a first load attribute and a second load attribute, the first load attribute corresponding to a first control parameter, the second load attribute corresponding to a second control parameter, the first load attribute being different from the second load attribute, and the first control parameter being different from the second control parameter; and
control the load to deliver the materials according to the determined control parameters.

In some embodiments, the load is provided with at least some components of a sensing apparatus. When the processor 141 implements the automatic detection of the load attributes of the load, the processor 141 is configured to:

Determine the load attributes of the load based on sensing parameters determined based on the signals sensed by the sensing apparatus.

In some embodiments, the load includes a detection chamber and a material chamber electromagnetically isolated from the detection chamber, and at least some components of the sensing apparatus are disposed in the detection chamber.

In some embodiments, when the processor 141 determines the load attributes of the load based on sensing parameters obtained from the signals sensed by the sensing apparatus, the processor 141 is configured to:
determine the load attributes of the load according to the sensing parameters and a preset mapping relationship between the sensing parameters and load attributes.

In some embodiments, the processor is further configured to:
output a preset alarm message or return to the process of automatically detecting the load attributes of the load if the load attributes corresponding to the sensing parameters are not found according to the mapping relationship.

In some embodiments, the sensing parameters include at least one of the following: sensing trigger time, sensing trigger frequency, or the intensity of the sensing signal.

In some embodiments, the sensing apparatus includes a plurality of first sensors and a plurality of second sensors arranged in pairs.

In some embodiments, the plurality of second sensors rotates with the rotation of the load, while the plurality of first sensors does not rotate with the rotation of the load.

In some embodiments, the plurality of second sensors is disposed at a rotating part of the load, and the plurality of first sensors is disposed at a non-rotating part of the load or at a part of the movable platform other than the load.

In some embodiments, the load includes a screw conveyor.

In some embodiments, the number of the plurality of first sensors and/or the plurality of second sensors disposed at the screw conveyor is negatively correlated with the screw pitch of the screw conveyor.

In some embodiments, the plurality of first sensors and/or the plurality of second sensors disposed at the screw conveyor are arranged at intervals along the circumferential direction of the screw conveyor.

In some embodiments, the distance between the plurality of first sensors and the plurality of second sensors varies with the rotation of the screw conveyor, and when the screw conveyor is in a target position, the screw conveyor can prevent material leakage, and the distance between the plurality of first sensors and the plurality of second sensors is the shortest.

In some embodiments, the load includes an RFID tag, and when the processor 141 automatically detects the load attributes of the load, the processor 141 is configured to: Determine the load attributes based on the RFID tag.

In some embodiments, when the processor 141 determines the corresponding control parameters based on the load attributes, the processor 141 is configured to:

Automatically configure the corresponding control parameters based on the load attributes and a preset mapping relationship between load attributes and control parameters.

In some embodiments, after the corresponding control parameters are determined based on the load attributes, the processor 141 is further configured to:
output parameter configuration prompt message corresponding to the control parameters, the parameter configuration prompt message being used to prompt the user to configure the control parameters;
automatically configure the control parameters.

In some embodiments, when the processor 141 delivers the material according to the control parameters, the processor 141 is configured to perform the at least one of the following:
adjusting the power parameters of the movable platform to achieve the determined control parameters;
adjusting the power parameters of the load to achieve the determined control parameters;
adjusting the configurations of the load to achieve the determined control parameters;
replacing the components of the load to achieve the determined control parameters.

In some embodiments, the processor is further configured to:
obtain the material category of the material;
automatically obtain the target load attributes of the load based on the material category;
determine corresponding control parameter based on the target load attributes. The target load attributes include a first target load attribute and a second target load attribute different from the first target load attribute, and a first control parameter corresponding to the first target load attribute is different from a second control parameter corresponding to the second target load attribute.

In some embodiments, when the processor 141 automatically obtains the target load attributes of the load based on the material category, the processor 141 is configured to:
automatically obtain the target load attributes of the load based on the material category and a preset mapping relationship between material categories and load attributes.

In some embodiments, when the processor 141 automatically obtains the target load attributes of the load according to the material category, the processor 141 performs at least one of the following:
selecting at least one load matching the material category from a plurality of different loads as the target load attributes;
selecting at least one sub-load matching the material category from a plurality of different sub-loads of the load as the target load attributes;
selecting at least one load operation configuration matching the material category from a plurality of different load operation configurations of the load as the target load attributes;
determining a load combination formed by configuring different cooperation modes between multiple loads based on the material category as the target load attributes.

In some embodiments, when processor 141 obtains the material category of the material, the processor 141 performs the following:
obtaining a target image containing the material;
determining the material category of the material based on the semantic information of the target image.

In some embodiments, the load attributes include at least one of the following: load category, load specification, or load operation configuration.

In some embodiments, the load includes a material conveying mechanism, and the control parameters include at least one of conveying control parameters or a first motion control parameter of the movable platform.

In some embodiments, the load includes a material dispensing mechanism, and the control parameters include at least one of a dispensing control parameter or a second motion control parameter of the movable platform.

In some embodiments, when the processor 141 implements automatic detection of the load attributes of the load, the processor 141 is configured to:

automatically detect the load attributes of the load in response to detecting that the load is installed in place on the movable platform or in response to detecting a power-on signal of the movable platform.

In some embodiments, the processor 141 is configured to execute a computer program stored in a memory 142, and, when executing the computer program, perform the following processes:
obtain the material category of the material to be dispensed;
automatically determine the target load attributes of the load based on the material category. The load is configured to deliver the material, the target load attributes include a first target load attribute and a second target load attribute, the first target load attribute corresponding to a first control parameter, the second target load attribute corresponding to a second control parameter, the first target load attribute being different from the second target load attribute, and the first control parameter being different from the second control parameter; and
control the load to deliver the material according to the control parameters corresponding to the target load attributes.

In some embodiments, after the process of automatically determining the target load attributes of the load, the processor 141 is further configured to implement any of the following:
if the movable platform does not have the load installed, output first information. The first information is configured to prompt the user to install the load having the target load attributes;
if the movable platform does not have the load installed, output a first instruction. The first instruction is configured to automatically install the load having the target load attributes.

In some embodiments, after the process of automatically determining the target load attributes of the load, the processor 141 is further configured to implement any of the following:
if the current load attributes of the load already installed on the movable platform are not the target load attributes, output second information. The second information is configured to prompt the user to replace the load;
if the current load attributes of the load already installed on the movable platform are not the target load attributes, output a second instruction. The second instruction is configured to automatically switch to the load having the target load attributes.

In some embodiments, when the processor 141 implements the automatic determination of the target load attributes of the load according to the material category, the processor 141 is configured to:
automatically determine the target load attributes of the load according to the material category and a preset mapping relationship between material categories and load attributes.

In some embodiments, when the processor 141 automatically determines the target load attributes of the load based on the material category, the processor 141 implements at least one of the following:
designating at least one load from a plurality of different loads that matches the material category as the target load attributes;
selecting at least one sub-load from a plurality of different sub-loads of the load that matches the material category as the target load attributes;
selecting at least one load operation configuration from a plurality of different load operation configurations of the load that matches the material category as the target load attributes;
determining a load combination formed by configuring different cooperation modes between multiple loads based on the material category as the target load attributes.

In some embodiments, when the processor 141 controls the load to deliver the material according to control parameters corresponding to the target load attributes, the processor 141 implements at least one of the following:
adjusting the power parameters of the movable platform to achieve control parameters corresponding to the target load attributes;
adjusting the power parameters of the load to achieve control parameters corresponding to the target load attributes;
adjusting the configurations of the load to achieve control parameters corresponding to the target load attributes;
replacing the components of the load to achieve control parameters corresponding to the target load attributes.

In some embodiments, when the processor 141 obtains the material category of the material, the processor 141 performs the following:
obtaining a target image containing the material;
determining the material category of the material based on the semantic information of the target image.

Those skilled in the art will understand that, for the sake of convenience and brevity, reference can be made to the corresponding process in the aforementioned embodiments of the control method of the load of a movable platform for the specific working process of the control apparatus described above.

FIG. 10 is a schematic structural diagram of a movable platform consistent with the present disclosure.

As shown in FIG. 10, the movable platform 100 includes a platform body 110, a power system 120, and a control apparatus 140. The platform body 110 carries the load 130, the power system 120 is disposed at the platform body 110 and provides mobility power to the movable platform 100, and the control apparatus 140 is disposed at the platform body 100 and controls the movable platform 100.

The present disclosure also provides a storage medium for computer-readable storage. The storage medium stores a computer program, the computer program including program instructions, and the processor executes the program instructions to implement the control method of the load of the movable platform provided in the above embodiments.

The storage medium may be an internal storage unit of the control apparatus or movable platform described in any of the foregoing embodiments, such as the hard disk or memory of the control apparatus or movable platform. The storage medium may also be an external storage device of the control apparatus or movable platform, such as a plug-in hard disk, smart media card (SMC), secure digital (SD) card, flash card, etc., provided at the control apparatus or movable platform.

It should be understood that the terminology used in this specification is for the purpose of describing specific embodiments only and is not intended to limit the scope of the present disclosure. As used in this specification and the appended claims, the singular forms “a,” “an,” and “the” are intended to include the plural forms unless the context clearly indicates otherwise. Similarly, the description of an item in the plural form does not preclude the embodiment in which an single one of the item is involved.

It should also be understood that the term “and/or” as used in this specification and the appended claims refers to any combination and all possible combinations of one or more of the associated listed items, and includes such combinations.

The above descriptions are merely specific embodiments of the present disclosure. However, the scope of the present disclosure is not limited thereto. Any person skilled in the art can easily conceive of various equivalent modifications or substitutions within the technical scope disclosed in the present disclosure, and such modifications or substitutions should be covered within the scope of the present disclosure. Therefore, the scope of the present disclosure should be determined by the scope of the claims.

What is claimed is:

1. A control method comprising:
automatically detecting load attributes of a load carried by a movable platform, the load being configured to deliver a material, and the load attributes including a first load attribute and a second load attribute different from the first load attribute;
determining control parameters based on the load attributes, the control parameters being configured to control the load to deliver the material and including a first control parameter corresponding to the first load attribute and a second control parameter corresponding to the second load attribute, and the first control parameter being different from the second control parameter; and
controlling the load to deliver the material according to the control parameters.

2. The control method according to claim 1, wherein:
the load is provided with one or more components of a sensing apparatus; and
automatically detecting the load attributes includes:
determining the load attributes based on one or more sensing parameters determined based on one or more signals sensed by the sensing apparatus.

3. The control method according to claim 2, wherein the load includes a detection chamber and a material chamber electromagnetically isolated from the detection chamber, and the one or more components are disposed in the detection chamber.

4. The control method according to claim 2, wherein determining the load attributes of the load based on the one or more sensing parameters includes:
determining the load attributes based on the one or more sensing parameters and a preset mapping relationship between sensing parameters and load attributes.

5. The control method according to claim 4, further comprising:
outputting a preset alarm message or returning to automatically detect the load attributes of the load in response to the load attributes corresponding to the sensing parameters not being found according to the mapping relationship.

6. The control method according to claim 2, wherein:
the sensing apparatus includes a first sensor and a second sensor arranged in a pair; and
the second sensor is configured to rotate with the load, and the first sensor is configured to not rotate with the load.

7. The control method according to claim 6, wherein the load includes a screw conveyor.

8. The control method according to claim 7, wherein:
the first sensor is one of a plurality of first sensors disposed at the screw conveyor and the second sensor is one of a plurality of second sensors disposed at the screw conveyor; and
the plurality of first sensors and/or the plurality of second sensors are arranged at intervals along a circumferential direction of the screw conveyor.

9. The control method according to claim 7, wherein a distance between the first sensor and the second sensors changes as the screw conveyor rotates, and, when the screw conveyor is at a target position, the screw conveyor is capable of preventing leakage of the material, and the distance between the first sensor and the second sensor is shortest.

10. The control method according to claim 1, wherein determining the control parameters includes:
automatically configuring the control parameters based on the load attributes and a preset mapping relationship between load attributes and control parameters.

11. The control method according to claim 1, wherein delivering the material includes at least one of:
adjusting one or more power parameters of the movable platform to achieve the control parameters;
adjusting power parameters of the load to achieve the control parameters;
adjusting a configuration of the load to achieve the control parameters; or
replacing one or more components of the load to achieve the control parameters.

12. The control method according to claim 1, wherein:
automatically detecting the load attributes includes:
obtaining a material category of the material; and
automatically obtaining target load attributes of the load based on the material category; and
determining the control parameters includes:
determining the control parameters based on the target load attributes.

13. The control method according to claim 12, wherein automatically obtaining the target load attributes includes:
automatically obtaining the target load attributes on the material category and a preset mapping relationship between material categories and load attributes.

14. The control method according to claim 12, wherein automatically obtaining the target load attributes includes at least one of:
selecting at least one load matching the material category from a plurality of different loads including the load as the target load attributes;
selecting at least one sub-load matching the material category from a plurality of different sub-loads of the load as the target load attributes;
selecting at least one load operation configuration matching the material category from a plurality of different load operation configurations of the load as the target load attributes; or
determining a load combination formed by configuring different cooperation modes between a plurality of loads based on the material category as the target load attributes, the plurality of loads including the load.

15. The control method according to claim 1, wherein the load attributes include at least one of a load category, a load specification, or a load operation configuration.

16. The control method according to claim 1, wherein automatically detecting the load attributes includes:
automatically detecting the load attributes in response to detecting that the load is installed in place on the movable platform or in response to detecting a power-on signal of the movable platform.

17. A control method comprising:
obtaining a material category of a target material to be delivered by a load carried by a movable platform;
automatically determining target load attributes of the load based on the material category, the target load attributes including a first target load attribute and a second target load attribute different from the first target load; and
controlling the load to deliver the target material according to control parameters corresponding to the target load attributes, the control parameters including a first control parameter corresponding to the first target load attribute and a second control parameter corresponding to the second target load attribute, and the first control parameter being different from the second control parameter.

18. The control method according to claim 17, further comprising, after automatically determining the target load attributes, at least one of:
in response to the movable platform not having the load installed, outputting information to prompt a user to install the load having the target load attributes; or
in response to the movable platform not having the load installed, outputting an instruction to automatically install the load having the target load attributes.

19. The control method according to claim 17, further comprising, after automatically determining the target load attributes, at least one of:
in response to current load attributes of the load installed on the movable platform not being the target load attributes, outputting information to prompt a user to replace the load; or
in response to the current load attributes of the load installed on the movable platform not being the target load attributes, outputting an instruction to automatically switch to a load having the target load attributes.

20. A movable platform comprising:
a platform body configured to carry a load, the load being configured to deliver a material;
a power system disposed at the platform body and configured to enable the movable platform to move; and
a control apparatus disposed at the platform body and configured to:
automatically detect load attributes of the load, the load attributes including a first load attribute and a second load attribute different from the first load attribute;
determine control parameters based on the load attributes, the control parameters being configured to control the load to deliver the material and including a first control parameter corresponding to the first load attribute and a second control parameter corresponding to the second load attribute, and the first control parameter being different from the second control parameter; and
control the load to deliver the material according to the control parameters.
